(19) United States
(12) Patent Application Publication
(10) Pub. No.: US 2008/0107874 A1
(43) Pub. Date: May 8, 2008

(54) Optical element including dielectric multilayer film and manufacturing method thereof

(75) Inventor: Nobuhiro Fukushima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 12/000,672

(22) Filed: Dec. 14, 2007

Related U.S. Application Data
(63) Continuation of application No. PCT/JP2005/012447, filed on Jul. 6, 2005.

(51) Int. Cl. B05D 5/06; B44C 1/17

(52) U.S. Cl. 428/195.1; 427/162

(57) ABSTRACT

An optical element including a dielectric multilayer film according to the present invention is configured such that the dielectric multilayer film is deposited onto one of faces of a substrate transparent to an incident light, and further, a stress relaxation film is deposited onto a surface of the dielectric multilayer film. The stress relaxation film includes an opening portion in a region through which the light can be passed, and is made of a material by which a direction of stress occurring in an interface to the dielectric multilayer film is consistent with a direction of stress occurring in an interface between the substrate and the dielectric multilayer film. As a result, a part of the stress occurring in the interface between the substrate and the dielectric multilayer film is negated by the stress occurring in the interface between the stress relaxation film and the dielectric multilayer film, so that an occurrence of curvature due the stress can be suppressed.

This application is a continuation of PCT/JP2005/012447, filed on Jul. 6, 2005.

### BACKGROUND OF THE INVENTION

1. Field of the Invention

The present invention relates to an optical element used for optical communications, and in particular, to an optical element including a dielectric multilayer film deposited onto a transparent substrate, and a manufacturing method thereof.

2. Description of the Related Art

A conventional optical element including a dielectric multilayer film which is typically utilized for the purpose of wavelength filter or the like, as shown in FIG. 8 for example, comprises: a substrate 101 made of a material such as glass transparent to an incident light L or the like; and a dielectric multilayer film 102 which is obtained by alternately depositing, onto the substrate 101, thin films made of a high refractive index material such as titanium dioxide (TiO₂), tantalum pentoxide (Ta₂O₅) or the like and thin films made of a low refractive index material such as silicon dioxide or the like. In the dielectric multilayer film 102, such that the optical film thickness (the actual thin film thickness x refractive index thereof of each thin film is designed to be ¼ of a previously determined design wavelength, and in many cases, thin films of from several layers to several hundred layers are laminated (refer to Japanese Unexamined Patent Publication No. 2000-314808).

In the conventional optical element including the dielectric multiplayer as described in the above, as shown in FIG. 9 for example, usually, an interface between the substrate 101 and the dielectric multilayer film 102 is stressed from the deposition time, due to a difference between a thermal expansion coefficient of the substrate 101 and that of the dielectric multiplayer film 102, and after the stress is released, the substrate 101 and the dielectric multilayer film 102 may be distorted resulting in the deformation called curvature. A deformation volume of this optical element tends to be increased as the number of layers of the dielectric multilayer film 102 is increased so that the filling density becomes higher.

In recent years, in an optical communication field, the research and development have been progressed on an optical transmission system applying a dense wavelength division multiplexing (DWDM) mode in which a plurality of optical signals of different wavelengths is allocated in short wavelength spacing. In this DWDM optical transmission system, in order to multiplex or demultiplex the optical signals of respective wavelengths for example, an optical filter of which transmission wavelength characteristics are steeply changed needs to be used. Such an optical filter having the steep transmission characteristics can be realized by increasing the number of layers of the dielectric multilayer film 102 in the optical element shown in FIG. 8, but is largely influenced by the above described curvature. For example, in the dielectric multilayer film 102 of the layers exceeding 70, since the deformation volume due to the curvature becomes equivalent to ¼ wavelength, there is caused a problem of the degradation of film characteristics. To be specific, a state where the above curvature occurs is equivalent to a state where films of different thickness are laminated, and therefore, the steepness of the transmission characteristics is lowered so that a loss in a desired wavelength is increased.

In order to reduce the above described curvature influence, for example a low filling density material (soft material) may be used for the dielectric multiplayer film 102 or a hard substrate material such as crystal or the like may be used for the substrate 101. However, the low filling density film is susceptible to an influence of moisture or the like, and therefore, in many cases, is not practical in view of the environmental resistance. Further, since the substrate material such as crystal or the like is expensive, and therefore, has a drawback that a cost of the optical element is increased.

### SUMMARY OF THE INVENTION

The present invention has been accomplished in view of the above problems, and has an object to provide an optical element of low cost, capable of relaxing a stress in an interface between a substrate and a dielectric multilayer film to suppress an occurrence of curvature so as to stably obtain required optical characteristics, and a manufacturing method thereof.

In order to achieve the above object, according to the present invention, an optical element including a dielectric multilayer film which is deposited onto one of faces of a substrate transparent to an incident light, comprises a stress relaxation film including an opening portion in a region through which the light can be passed, in which a lower face of a portion surrounding the opening portion is attached firmly to a surface of the dielectric multilayer film, and also, being made of a material by which a direction of stress occurring in an interface to the dielectric multilayer film is consistent with a direction of stress occurring in an interface between the substrate and the dielectric multilayer film.

In the optical element as described above, the stress relaxation film including the opening portion is disposed to be attached firmly onto the surface of the dielectric multilayer film of the above described conventional optical element, so that a part of the stress occurring in the interface between the substrate and the dielectric multilayer film is negated by the stress occurring in the interface between the stress relaxation film and the dielectric multilayer film, and consequently, an occurrence of curvature due to the stress occurring in the interface between the substrate and the dielectric multilayer film can be suppressed.

Further, in the above optical element, it is preferable that the opening portion has an area larger than a spot region of an optical beam passing through a predetermined position, and the thickness of the stress relaxation film is set in proportion to a distance of an outer edge of the spot region of the optical beam to an inner wall of the opening portion. In such a configuration, even in the case where the opening portion needs to have room for disposing an optical system for the optical element, by setting the thickness of the stress relaxation film in proportion to the distance of the outer edge of the spot region of the optical beam to the inner wall of the opening portion, an available stress relaxation effect can be achieved.

Furthermore, the above stress relaxation film of the optical element may be vapor-deposited onto the surface of the dielectric multilayer film. As a result, it becomes possible to form the stress relaxation film by a simple vapor deposition process similar to that of a typical insulating film or the like.

According to the present invention, a manufacturing method of an optical element including a dielectric multilayer film which is deposited onto one of faces of a substrate transparent to an incident light, comprises the processes of: depositing the dielectric multilayer film onto a wafer serving as the substrate; forming a mask pattern corresponding to a position of a region through which the light can be passed, on a surface of the deposited dielectric multilayer film; depositing in grid a stress relaxation film made of a material by which a direction of stress occurring in an interface to the dielectric multilayer film is consistent with a direction of stress occurring in an interface between the substrate and the dielectric multilayer film, on the surface of the dielectric multilayer film, via the formed mask pattern; eliminating the mask pattern; and cutting the wafer, the dielectric multilayer film and the stress relaxation film along grid center lines of the stress relaxation film, to obtain optical element in plural numbers.

According to the above manufacturing method, the optical element according to the present invention can be easily manufactured in plural numbers from a single wafer.

According to the optical element including the dielectric multilayer film according to the present invention as described above, even if the number of layers of dielectric multilayer films is increased, since an occurrence of curvature due to the stress can be suppressed by disposing the stress relaxation film, it becomes possible to stably obtain steep filter characteristics. Further, even in the case where a relatively wide room portion needs to be ensured for disposing an optical system, by determining the thickness of the stress relaxation film in proportion to the distance of the outer edge of the spot region of the optical beam to the inner wall of the opening portion, the occurrence of curvature due to the stress can be reliably suppressed. Furthermore, it becomes possible to provide the optical element at a low cost by forming the stress relaxation film by the deposition process similar to that of the typical insulating film or the like.

The other objects, features, advantages and various aspects of the present invention will become more apparent from the ensuing description of preferred embodiments with reference to the accompanying drawings.

### BRIEF DESCRIPTION OF THE DRAWING

FIG. 1 is a perspective view showing a configuration of an optical element according to one embodiment of the present invention.

FIG. 2 is a side sectional view of FIG. 1.

FIG. 3 is a top view of FIG. 1.

FIG. 4 is a diagram showing one example of a manufacturing process of the optical element according to the above embodiment.

FIG. 5 is a top view exemplarily showing states of a dielectric multilayer film and a stress relaxation film formed on a wafer.

FIG. 6 is a perspective view showing a modified example in which an opening portion is formed in circular shape, relating to the above embodiment.

FIG. 7 is a perspective view showing a modified example in which a contour of the optical element is formed in disk shape, relating to the above embodiment.

FIG. 8 is a perspective view showing one example of a conventional optical element including a dielectric multilayer film.

FIG. 9 is a diagram for explaining an occurrence of curvature due to a stress in the conventional optical element.

### DESCRIPTION OF THE PREFERRED EMBODIMENTS

There will be described embodiments for implementing an optical element including a dielectric multilayer film according to the present invention, with reference to the accompanying drawings. The same reference numerals denote the same or equivalent parts in all drawings.

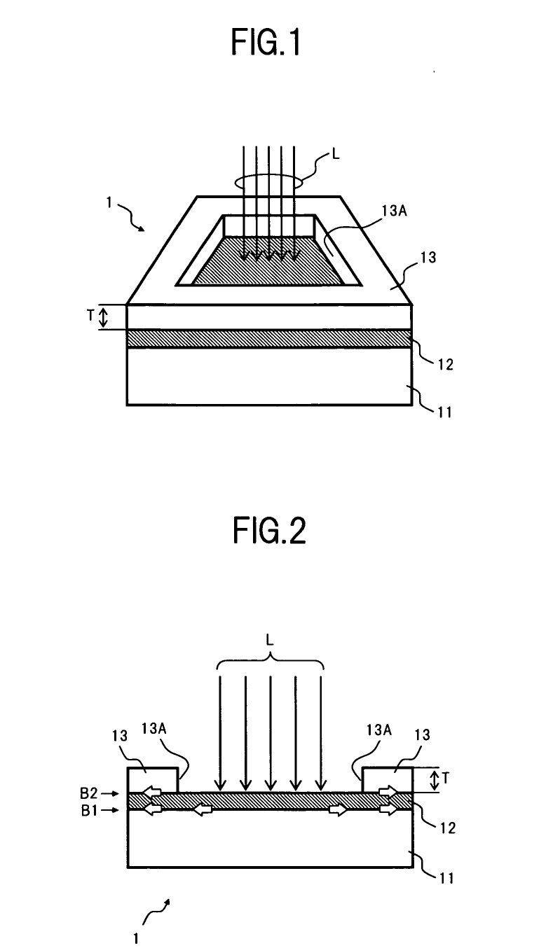

FIG. 1 is a perspective view showing a configuration of an optical element according to one embodiment of the present invention. Further, FIG. 2 is a side sectional view of FIG. 1.

In FIG. 1 and FIG. 2, an optical element 1 in the present embodiment comprises, for example; a substrate 11 made of a material transparent to an incident light L; a dielectric multilayer film 12 deposited onto one of faces of the substrate 11; and a stress relaxation film 13 deposited onto a surface, which is positioned on the opposite side of the substrate 11, of the dielectric multilayer film 12.

The substrate 11 and the dielectric multilayer film 12 are similar to those used in the above described conventional optical element. Herein, a glass substrate is used as a specific example of the substrate 11. However, the material of the substrate 11 is not limited to glass, and it is possible to use a known material transparent to the incident light L. The dielectric multilayer film 12 is configured such that thin films made of a material having the relatively high refractive index (for example, titanium dioxide (TiO₂), tantalum pentoxide (Ta₂O₅) or the like) and thin films made of a material having the relatively low refractive index (for example, silicon dioxide (SiO₂) or the like) are alternately laminated so that the optical film thickness of each layer is ¼ of a previously determined design wavelength. Further, the number of layers of the dielectric multilayer film 12 is set in view of the steepness of transmission (or reflective) wavelength characteristics. By appropriately designing optical characteristics of the dielectric multilayer film 12, the present optical element 1 functions as a band-pass filer which transmits a light in a predetermined set wavelength band, a long wave-pass filter which transmits a light on the longer wavelength side of a previously set wavelength, or a short wave-pass filter which transmits a light on the shorter wavelength side of the previously set wavelength.

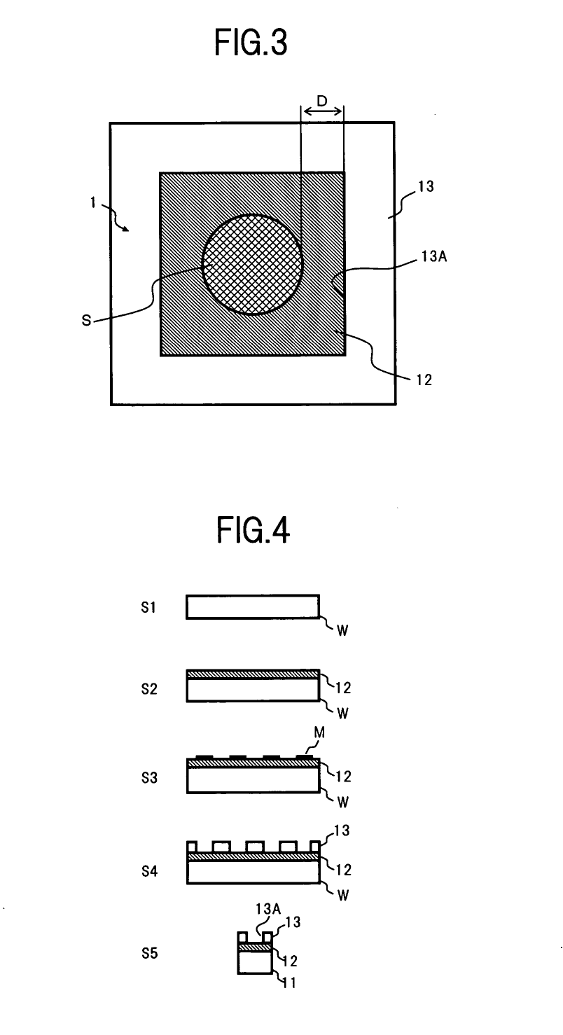

The stress relaxation film 13 includes, for example a square opening portion 13A in a region through which the incident light L can be passed, and a lower face of a portion surrounding the opening portion 13A is attached firmly to the surface of the dielectric multilayer film 12. As shown in FIG. 2, the stress relaxation film 13 is formed using a material by which a direction of stress (white arrow) occurring in an interface B2 to the dielectric multilayer film 12 is consistent with a direction of stress (white arrow) occurring in an interface B1 between the substrate 11 and the dielectric multilayer film 12. Namely, the material of the stress relaxation film 13 is determined so that, in the case where the stress occurring in the interface B1 is a tensile stress (or a compressive stress) to the dielectric multilayer film 12, the stress occurring in the interface B2 is also the tensile stress (or the compressive stress) to the dielectric multilayer film 12. As a specific material of the stress relaxation film 13, in view of the firm attachment (undetachability) to the dielectric multilayer film 12, it is possible to use, for example, silicon dioxide (SiO₂), tantalum pentoxide (Ta₂O₅), niobium pentoxide (Nb₂O₅) or the like), relative to the above described substrate 11 and the dielectric multilayer film 12. Further, as shown in a top view of FIG. 3 for example, the thickness T of the stress relaxation film 13 is set in proportion to a distance D of an outer edge of a spot region S of an optical beam incident onto a predetermined position to an inner wall of the opening portion 13A.

However, the material of the stress relaxation film in the present invention is not limited to the above specific example. Further, in the configuration of the present invention, since the light does not pass through the stress relaxation film 13, it is possible to use a material which is not transparent to an optical wavelength, for the stress relaxation film 13.

Here, there will be described the principle in which a curvature due to the stress occurring in the interface B1 between the substrate 11 and the dielectric multilayer film 12 can be suppressed by disposing the stress relaxation film 13 as described above, referring to FIG. 2.

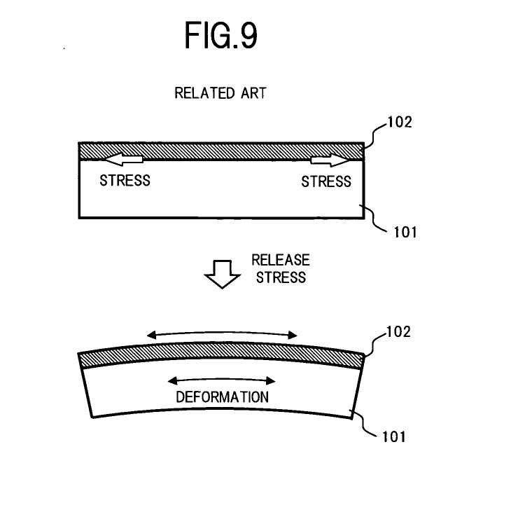

In an outer peripheral portion in which the stress relaxation film 13 of the present optical element 1 is formed, as shown by the white arrow in FIG. 2, an action for deforming the substrate 11 by the stress occurring in the interface B1 between the substrate 11 and the dielectric multilayer film 12 is negated by the stress in the same direction which occurs in the interface B2 between the dielectric multilayer film 12 and the stress relaxation film 13. As a result, although the stress occurring in the interface B1 between the substrate 11 and the dielectric multilayer film 12 remains in the center portion corresponding to the opening portion 13A, the action due to the stress in the interface B1 which occurs the curvature as shown in FIG. 9 is relaxed in the optical element 1 as a whole, and consequently, it becomes possible to suppress the occurrence of curvature of ¼ wavelength level, which adversely affects the optical characteristics.

In order to further effectively suppress the occurrence of curvature due to the stress based on the above principle, it is desired that the stress relaxation film 13 is disposed as closer as possible to the spot region S (refer to FIG. 3) of the incident optical beam. However, in the case of considering assembling operations of the optical system, it is necessary to make the opening portion 13A larger at a certain degree relative to the spot region S to thereby form a room portion for disposing the optical system, but if this room portion is made larger, a stress relaxation effect obtained by the stress relaxation film 13 becomes less. Therefore, in the present embodiment, by making the stress relaxation film 13 thicker according to the width of the room portion, an increase of the stress relaxation effect is achieved. At this time, since a minute deformation region of ¼ wavelength level may be considered as the curvature degree due to the problematic stress, it is possible to consider that the thickness T of the stress relaxation film 13 necessary for availably relaxing the stress occurring in the interface B1 corresponding to the room portion is in proportion to the distance D of the outer edge of the spot region S to the inner wall of the opening portion 13A. Namely, when the designing is made so that the distance D is doubled, by making the thickness T of the stress relaxation film 13 to be doubled, it becomes possible to suppress the occurrence of curvature due to the stress, which adversely affects the filter characteristics.

Next, there will be described a manufacturing method of the optical element 1 as described above.

FIG. 4 shows one example of a manufacturing process of the optical element 1. Firstly, a wafer W serving as the substrate 11 is prepared (S1), and the dielectric multilayer film 12 is deposited onto the entire one face of the wafer W (S2). Next, on the surface of the dielectric multilayer film 12, a mask pattern M is formed corresponding to the position of the opening portion 13A (S3), and thereafter, the stress relaxation film 13 is vapor-deposited in grid via the mask pattern M, and further, the mask pattern M is eliminated using chemicals (S4).

Incidentally, in the vapor-deposition process of the stress relaxation film 13, a deposition time does not need to be controlled with high precision for forming the optical film thickness of ¼ wavelength, differently from the deposition process of the dielectric multilayer film 12, and accordingly, it is possible to form the stress relaxation film 13 of the thickness T (for example, 0.5 mm to 1 mm) by a simple vapor-deposition process similar to a vapor-deposition process of a typical insulating film or the like.

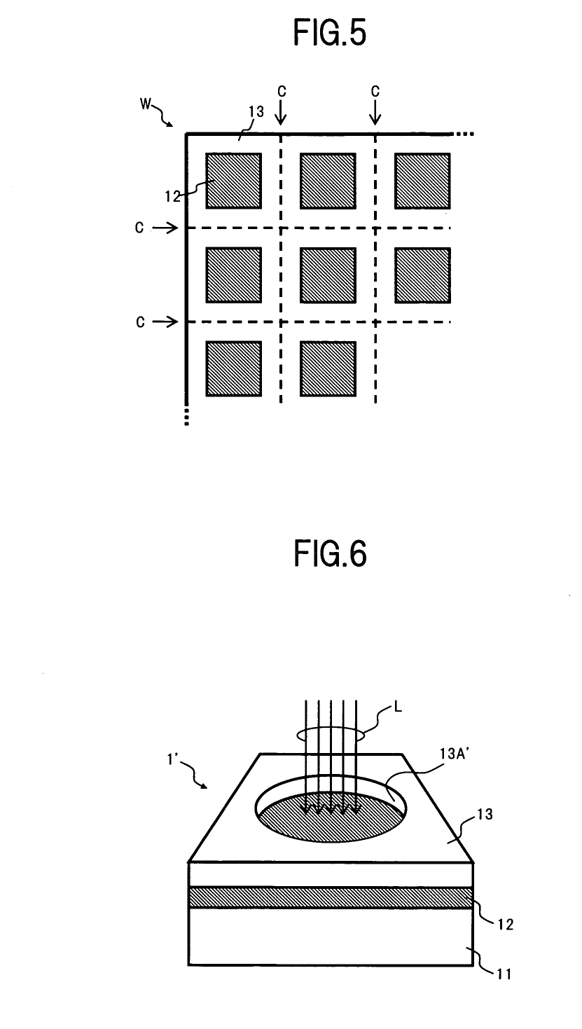

According to the above each process, as shown in FIG. 5, the wafer W in which the stress relaxation film 13 is formed in grid on the dielectric multilayer film 12 is obtained, and consequently, is cut along grid center lines C shown by broken lines in the figure by a dicing saw or the like (S5). As a result, the optical element 1 is efficiently manufactured in plural numbers from one wafer W.

As described in the above, according to the optical element 1 in the present embodiment, since it is possible to suppress the occurrence of curvature by disposing the stress relaxation film 13 even though the number of layers of the dielectric multilayer film 12 is increased, it becomes possible to stably obtain the steep filter characteristics without the necessity of using the low filling density (soft) material for the dielectric multilayer film 12. Further, since the stress relaxation film 13 can be formed by the simple vapor-deposition process similar to that of the insulating film or the like, and also, it is not especially necessary to use an expensive crystal substrate or the like as the substrate material, it is possible to provide the optical element 1 at a low cost. Furthermore, by determining the thickness of the stress relaxation film 13 in proportion to the distance D of the outer edge of the spot region S of the optical beam to the inner wall of the opening portion 13A, it becomes possible to reliably suppress the occurrence of curvature due to the stress even in the case where the relatively large room portion needs to be ensured for disposing the optical system.

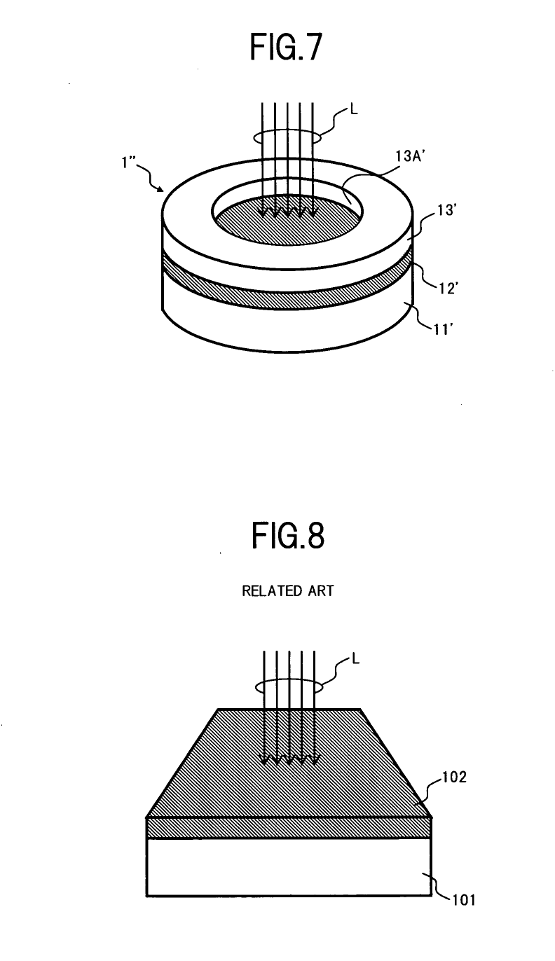

Incidentally, in the above embodiment, there has been shown the one example in which the opening portion 13A is formed in square shape. However, the present invention is not limited to the above, a circular opening portion 13A may be formed as shown in an optical element 1′ of FIG. 6 for example. Further, the contour of the optical element is not limited to the square shape, and as shown in an optical element 1″ of FIG. 7 for example, contours of a substrate 11′, a dielectric multilayer film 12′ and a stress relaxation film 13′ may be formed in disk shapes (circular shapes). In the case of square shape, since the cutting from the wafer can be performed by only the dicing saw, advantages in excellent productivity can be obtained. In the case of disk shape, advantages in homogenous stress can be obtained.

What is claimed is:

1. An optical element including a dielectric multilayer film which is deposited onto one of faces of a substrate transparent to an incident light, comprising;
a stress relaxation film including an opening portion in a region through which the light can be passed, in which a lower face of a portion surrounding the opening portion is attached firmly to a surface of the dielectric multilayer film, and also, being made of a material by which a direction of stress occurring in an interface to the dielectric multilayer film is consistent with a direction of stress occurring in an interface between the substrate and the dielectric multilayer film.

2. An optical element according to claim 1,
wherein the opening portion has an area larger than a spot region of an optical beam passing through a predetermined position, and
the thickness of the stress relaxation film is set in proportion to a distance of an outer edge of the spot region of the optical beam to an inner wall of the opening portion.

3. An optical element according to claim 1,
wherein the stress relaxation film is vapor-deposited onto the surface of the dielectric multilayer film.

4. An optical element according to claim 1,
wherein the stress relaxation film is formed using any one of materials, silicon dioxide, tantalum pentoxide and niobium pentoxide.

5. An optical element according to claim 1,
wherein the dielectric multilayer film is provided with optical characteristics transmitting a light in previously set wavelength band.

6. An optical element according to claim 1,
wherein the dielectric multilayer film is provided with optical characteristics transmitting a light on the longer wavelength side of a previously set wavelength.

7. An optical element according to claim 1,
wherein the dielectric multilayer film is provided with optical characteristics transmitting a light on the shorter wavelength side of a previously set wavelength.

8. An optical element according to claim 1,
wherein a contour of the substrate is formed in square shape.

9. An optical element according to claim 1,
wherein a contour of the substrate is formed in disk shape.

10. A manufacturing method of an optical element including a dielectric multilayer film which is deposited onto one of faces of a substrate transparent to an incident light, comprising the processes of:
depositing the dielectric multilayer film onto a wafer serving as the substrate;
forming a mask pattern corresponding to a position of a region through which the light can be passed on a surface of the deposited dielectric multilayer film;
depositing in grid a stress relaxation film being made of a material by which a direction of stress occurring in an interface to the dielectric multilayer film is consistent with a direction of stress occurring in an interface between the substrate and the dielectric multilayer film, on the surface of the dielectric multilayer film, via the formed mask pattern;
eliminating the mask pattern; and
cutting the wafer, the dielectric multilayer film and the stress relaxation film along grid center lines of the stress relaxation film, to obtain the optical element in plural numbers.
